(19) United States
(12) Patent Application Publication
(10) Pub. No.: US 2018/0174259 A1
(43) Pub. Date: Jun. 21, 2018

(54) SYSTEM AND METHOD FOR ASSISTING AN OFFENDER DURING THE TRANSITION FROM INCARCERATION TO RELEASE

(71) Applicant: GLOBAL TEL*LINK CORP, Reston, VA (US)

(72) Inventor: Stephen Lee HODGE, Aubrey, TX (US)

(21) Appl. No.: 15/385,047

(22) Filed: Dec. 20, 2016

(51) Int. Cl. G06Q 50/26; G06F 17/30; G06Q 10/10

(52) U.S. Cl. CPC G06Q 50/265; G06Q 10/10; G06F 17/30377

(57) ABSTRACT

The present disclosure provides details of a system and method to assist an offender during the transition from incarceration to release. Such a system may generate a profile of a transitioning offender and provide services to the offender. Such a system may respond to good behaviors from the offender by updating the services and relaxing the supervision assistance with a positive feedback mechanism. Such progressive relaxation of supervision assistance may smoothen transitioning offender's life transition and reduce the chance of recidivism.

### BACKGROUND

### Field

The disclosure relates to a system and method for assisting offenders during the transitions from incarceration to full release.

### Background

In today's correctional facilities, an offender follows a controlled and very event-driven lifestyle. There are certain hours of the day that each event takes place in the offender's life. Most activities, such as exercise, meals, work, and sleep, are done at predetermined times of each day. After the offender is released into society, this strictly organized event-driven lifestyle ceases abruptly, leaving the transitioning offender with an uncontrolled and unguided daily schedule. This unguided daily routine can be very stressful for someone used to constant structured daily routines, and thus can often lead the transitioning offender to his or her old lifestyle before incarceration. This can greatly increase the chance of relapsing, which is highly undesired.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of an Offender Transition Assistance System 100 according to embodiments of the present disclosure.

FIG. 2 illustrates a block diagram of a computer-implemented Central Server 101 for the offender transition assistance system according to an embodiment of the present disclosure.

FIG. 3 illustrates a block diagram of a Profile 202 according to an embodiment of the present disclosure.

FIG. 4 illustrates a block diagram of a Service List 205 according to an embodiment of the present disclosure.

FIG. 5 illustrates a block diagram of a Wireless Device 106 according to an embodiment of the present disclosure.

FIG. 6 illustrates a flowchart diagram of a method of Offender Profile Generation and Wireless Device Initialization according to an embodiment of the present disclosure.

FIG. 7 illustrates a flowchart diagram of a method of providing transition assistance services to a transitioning offender with a positive feedback mechanism according to an embodiment of the present disclosure.

FIG. 8 illustrates a flowchart diagram of a method of providing communication monitor services with a positive feedback mechanism according to an embodiment of the present disclosure.

FIG. 9 illustrates a computer system, according to an embodiment of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “for example”, “for instance”, “in some embodiments”, “one exemplary embodiment, ” “an exemplary embodiment, ” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular features structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function, either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Overview

A system that maintains a tight supervision for an offender when the offender is incarcerated and just released to the society, then progressively relaxes the transitioning offender's daily schedule control during the transition period can reduce the impact from the interruption of the offender's lifestyle. Further, a system that rewards a transitioning offender when the offender establishes good behaviors can greatly enhance the offender's confidence and encourage the offender to maintain the good behaviors.

Meanwhile, Electronic Devices (e.g. Tablets and Smartphones) are used more and more often by the offender population for communication services. The electronic device can also be equipped with clocks, calendar, scheduling, reminders, mapping, GPS, Chatbots, microphone, speaker display, data entry means, processors, applications and memory systems. These devices also include wearable devices that can be easily carried along. Thanks to their wide range of functionality, these devices are able to provide much more than communication services for the offenders; they are able to provide invaluable assistance to the offenders during transition.

In light of the above, the present disclosure provides details of a progressive transition assistance system and a method for an offender to transition smoothly from incarcerated life to normal societal life. According to an embodiment of the present disclosure, such a progressive system includes a central server that processes and stores all the information for the offender, one or more remote server communicating with the central server and a plurality of wireless devices, a plurality of terminals for the jurisdiction officials to interact with the central server and the remote servers, a plurality of wireless devices that are configured to communicate with a central server and/or a remote server to provide assistance and services to the offender.

Besides the communication services, the offender transition assistance system is configured to assist the offender by providing a feedback mechanism to encourage and award offender's positive activities, such as staying on schedule, completing a General Education Development (GED) course, and meeting officer on time, according to an embodiment of the present disclosure. The wireless devices of the offender automatically monitors and records the offender's behavior and activities, such as text messaging, education progress, and range of activities, and sends the data to the central server for behavior analysis. Based on predefined models or rules, the central server determines whether the behaviors or activities meet a predefined goal or milestone; the central server also determines if a positive trend has been established in the transitioning offender's activity; if the goal or milestone is met, or a positive trend is established, the system displays acknowledging and encouraging text message on the wireless device of the transitioning offender, and/or reduces the supervision intensity or frequency for the transitioning offender as a reward for the good behaviors, and/or provides other forms of rewards to provide the positive feedback. The more goals or milestones are met or more positive trends are established, the less intense or frequent the supervision assistance will be applied to the transitioning offender. Eventually, supervision assistance will be completely removed for the transitioning offender and the transition is thus complete.

The offender transition assistance system thus aims to ease the life style change when the offender transitions from incarceration to fully release by progressively relaxing the life style supervision services for the offender during the transitory period.

### Offender Transition Assistance System

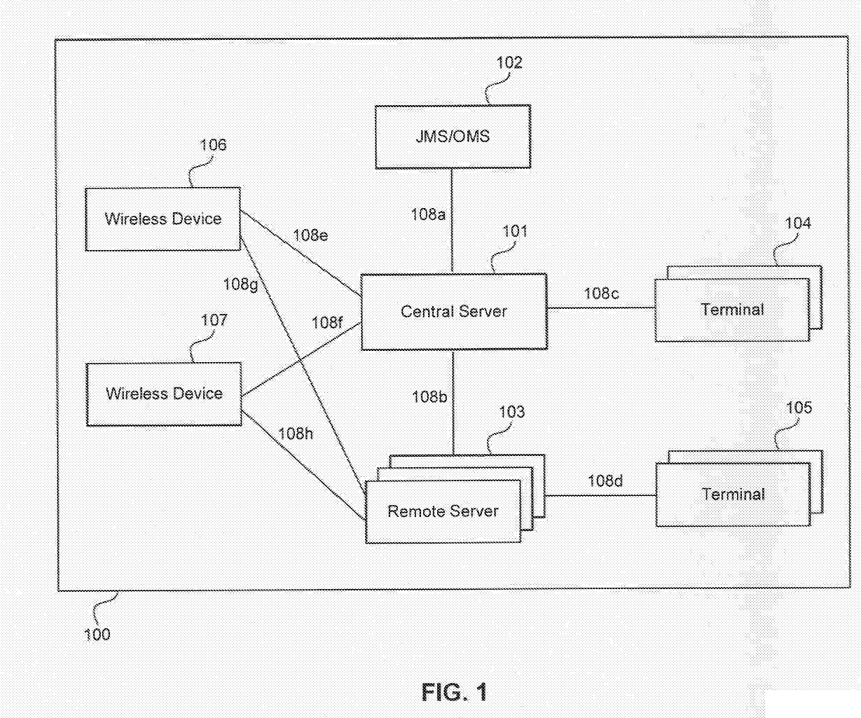

FIG. 1 illustrates a block diagram of an Offender Transition Assistance System (OTAS) 100, according to an embodiment of the present disclosure. As shown by FIG. 1, offender transition assistance system 100 comprises a central server 101 that processes data and hosts data. The data includes, but is not limited to, offender records and profiles, system operation rules and models, the database for all the services to be provided, communication records, voice data, text data, and location data. The system further includes a Jail Management System (JMS) and an Offender Management System (OMS) that manages and hosts detailed criminal records of offenders. The central server communicates with the JMS or OMS regarding at least the records of offenders. The system also includes one or more of a remote server 103, such as a probation monitoring system server, a parole monitoring system server, or a home monitoring system server. The remote server 103 communicates with a central server 101 to send and receive data, such as offender records, profiles, and services. The system also comprises a plurality of terminals 104 and 105. The terminals are used by authorized personnel to interact with a central server 101 or one or more of a remote server 103. Further, the system includes one or more wireless devices 106 and 107. The wireless devices are used by the offenders and can provide a wide range of services. The wireless devices communicate with a central server 101 and/or one or more remote server 103, to send and receive data. The connections 108a-h are wired (e.g. Ethernet) or wireless connection, where the wireless connection may be implemented as a wide-area network (WAN) connection, local area network (LAN) connection, the Internet, a cellular connection, a WIFI connection, a Bluetooth connection, or an infrared connection. Other types of implementations for a wired or wireless connection are possible without deviating from the scope of the invention.

### Central Server

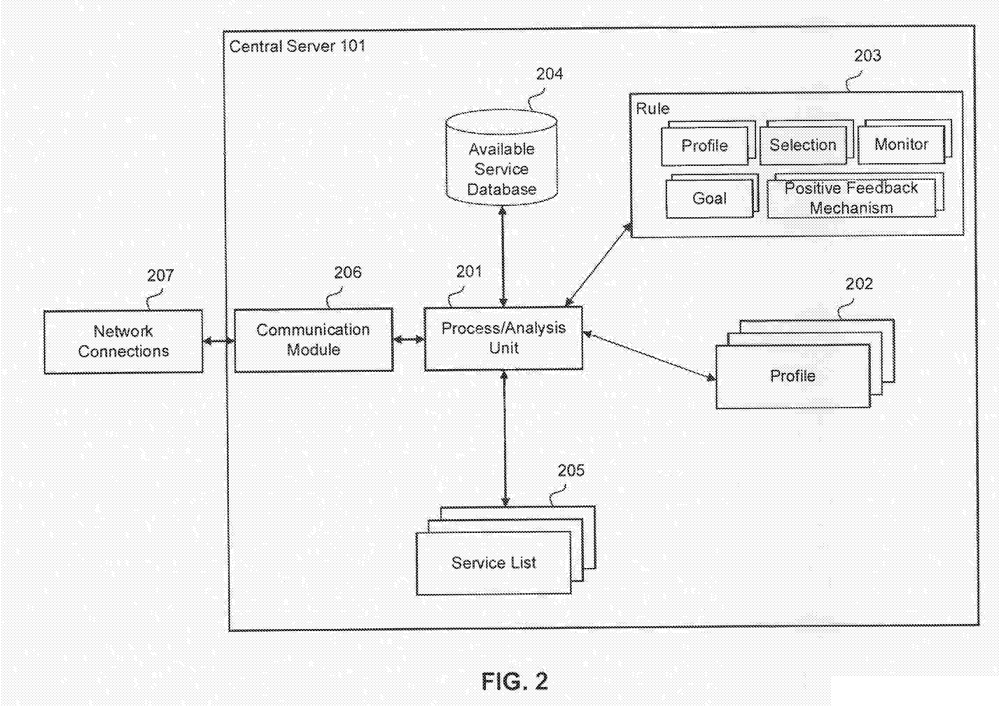

FIG. 2 illustrates a block diagram of a central server 101, according to an embodiment of the present disclosure. According to the embodiment shown by FIG. 2, the central server 101 comprises a Process and Analysis Unit 201, a Profile database 202, a Rule database 203, an Available Service database 204, a Service List database 205, and a communication module 206. Databases 202, 203, 204, 205 may be implemented as a hard drive, a flash drive, a server, multiple servers, a centralized storage area network (SAN), or any other configuration of storage devices. The communication module 206 is configured so receive data from different sources through the connections, such as JMS/OMS 102, a plurality of terminals 104, one or more of a remote server, and a plurality of wireless devices 106 and 107. The communication module 206 is fun her configured to send the received data to the Process and Analysis Unit 201. The communication module 206 is also configured to receive data from the Process and Analysis Unit 201 and send data to a recipient, such as JMS/OMS 102, a remote server 103, a plurality of terminals 104, a plurality of wireless devices 106 and 107. The communication module 206 is configured to receive and send data through the Network Connections 207, such as connections 108a, 108b, 108c, 108e, and 108f.

The Process and Analysis Unit 201 is configured to receive data from and send data to communication module 206, the Profile databases 202, the Rule database 203, the Available Service database 204, and the Service List 205. The Process and Analysis Unit is also configured to execute different functions including, but not limited to, receiving data from and sending data to the communication module 206, analyzing the data to identify a command, executing a predefined action according to the command, modifying the data according to the predefined rules and models, and fetching the data from and saving data to specific databases.

Rule 203 is a collection of rules, models, and protocols for the Process and Analysis Unit to follow during operation. Rule 203 includes, but is not limited to, Profile rules, Selection rules, Monitor rules, Positive Feedback Mechanisms, and Goal rules that are predefined for the system. The Profile rules are rules for the Process and Analysis Unit to generate data to complete the offender's profile based on limited profile data. The Selection rules are rules based on which the Process and Analysis Unit can select a list of services from Available Service Database 204 to generate a Service List 205 according to the offender's profile. The Monitor rules are rules that the Process and Analysis Unit follows when it is analyzing the activity monitoring data received from wireless devices for individual offenders. For instance, the Monitor rules include a communication monitor rule that defines categories of good and bad communication words spotted in offender's text messages. The Goal rules are rales that define the completion criteria of each goal or each milestone and the actions to be taken by the Process and Analysis Unit when a specific goal or milestone is reached. For instance, a Goal rule defines a Reporting Goal to be reporting to the probation officer on time for 10 consecutive times. This Goal rule further defines that, once this requirement is met, the Process and Analysis Unit updates the offender's profile to mark this goal to be completed. The Positive Feedback Mechanisms are detailed feedback models based on which the OTAS 100 determines when and how to adjust the offender's profile and the offender's supervision assistance. For instance, a Positive Feedback Mechanism defines that once the Reporting Goal is completed, the supervision level in the offender's profile can be reduced by one level. This change in supervision level further results in a one-time notification service that sends a congratulation text to the offender to notify this goal status, and may further result in a change in the Service List 205 and a relaxation in specific supervision assistance services being provided to the offender.

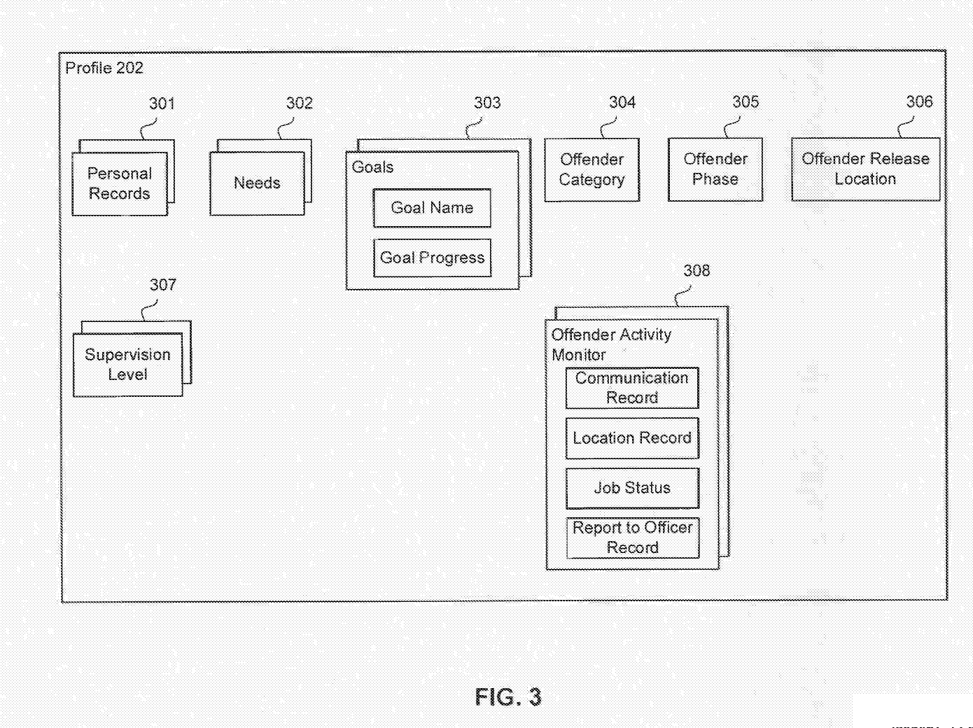

FIG. 3 provides a block diagram of Profile 202, according to an embodiment of the present disclosure. As shown by FIG. 3, Profile 202 hosts detailed data about the offender. Profile 202 includes, but is not limited to, Personal Records 301, Needs 302, Goals 303, Offender Category 304, Offender Phase 305, Offender Release Location 306, Supervision Level 307, Offender Activity Monitor Status 308. The data is used to not only identify the offender, but also categorize the offender and track the offender's activity and status during the life transition. Personal Records 301 is a list of detailed personal and criminal information for the offender, such as offender's basic and biometric information, offender's criminal history, offender's social relationships, and offender's links to gangs. The Personal Records 301 is synchronized with the offender's information on JMS/OMS 102. Needs 302 is a collection of needs or gaps identified based on offender's personal information and criminal history. For instance, an offender lacking temperament control may have a need for mental health assistance and Needs 302 then includes the need for mental health assistance. Goals 303 is a collection of goals that have been agreed on by the Offender and the Jurisdiction. Goals 303 includes goals that have been assigned to the offender by the Jurisdiction. Goals 303 comprises detailed information of the goals, such as Goal Name and Goal Progress. For instance, the Goal Name is Completing a GED Course, and the Goal Progress is the status of the completion of the course, such as 25% complete, 50% complete or 100% complete. Offender Category 304 is an indication of the offender's risk of recidivism based on the offender's crime nature and history. For instance, an offender who committed high degree assault repeatedly and have ties to gangs may have an Offender Category of “high risk”, while an offender who committed low degree assault only once with a relatively clean history may have an Offender Category of “low risk”. Offender Category 304 is used by OTAS 100 to provide tighter supervision assistance services to the offenders with higher risk of recidivism. Offender Phase 305 is an indication of the current incarceration stage of the offender. For instance, the Offender Phase 305 may be incarcerated, probation, or fully released. Offender Release Location 306 is the target location where the offender is released to. Supervision Level 307 is an indicator of the frequency and intensity of the current supervision assistance service that is provided to the offender. Supervision Level 307 can be a single global level to control all the services, or a list of levels that each controls a specific list of services. According to an exemplary embodiment, Supervision Level 307 is gradually and automatically reduced from higher to lower and to zero following a predefined positive feedback mechanism. Offender Behavior Monitor 308 is a collection of data regarding the offender's activities. The data includes, but is not limited to, Communication Record, Location Record, Job Status, and Report to Officer Record, etc. Further, the Communication Record included records of the good and bad events happened during the offender's communication. The Location Record includes records of the locations the offender has been to. The Job Status includes records of the offender's current job information and job performance. Reporting to Office Record includes records of when the offender is reporting to a local probation or parole officer and whether the reporting has been on time. Profile 202 can be automatically or manually updated as long as new data of the offender has been received or collected by the OTAS 100.

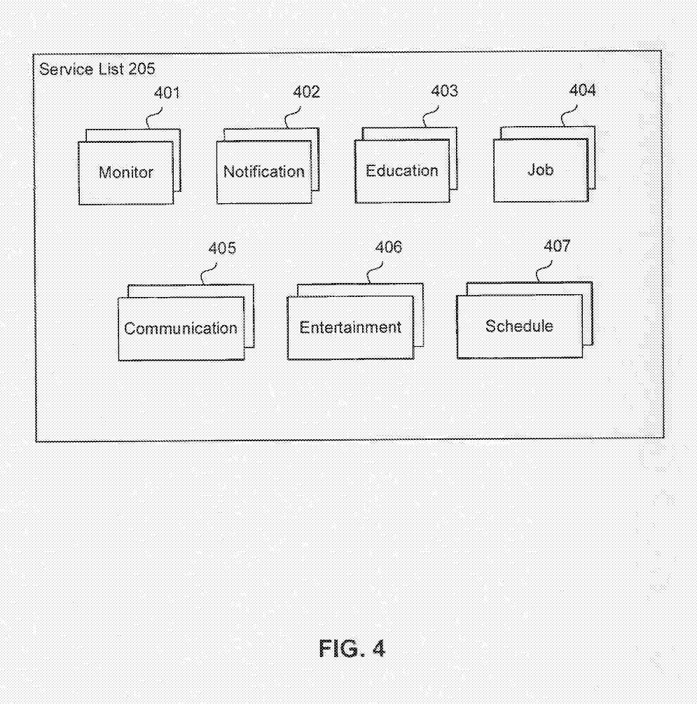

FIG. 4 provides a block diagram of a Service Lisl 205. According to an embodiment shown by FIG. 4, Service List 205 includes a list of different services or functions that are currently provided to the offender. The services and functions include, but are not limited to, Monitor 401, Notification 402, Education 403, Job 404, Communication 405, Entertainment 406, and Schedule 407. Monitor 401 is a collection of monitor services or functions that are provided to the offender, such as tracking the locations of the offender and monitoring the text messages sent by the offender. Notification 402 is a collection of services that provide notifications to the offender for specific events. For instance, Notification 402 includes instantly sending a text notification to display on the offender's wireless device when the offender completes a specific goal or reaches a milestone. For another example, the Notification 402 includes sending a vibration or beep warning notification to the offender's wireless device when the offender is near a undesired region. For yet another example, the Notification service includes sending out text and vibration reminder notifications to the offender's wireless device to remind the offender of an upcoming appointment. Education 403 is a collection of different education related services that are provided to the offender. For instance, Education service 403 includes class registration, class preparation, online class participation, and homework submission services for the offender. Job 404 is a collection of different job related services that are provided to the offender. For instance, Job 404 includes recommending related new jobs to the offender, providing job interview preparation assistance, and job performance feedback services. Communication 405 includes a number of different communication services that are provided to the offender. The Communication services include, but are not limited to, voice call, video call, text message, email, and other forms of communications. Entertainment 406 is a collection of entertainment services that are provided to the offender. Entertainment 406 includes, but is not limited to, online shopping, internet browsing, video games, and music. Schedule 407 is a collection of services provided to the offender to receive event invitations, schedule and modify events, set up reminders, and set up follow-up task items. According to an embodiment presented in the disclosure, the offender is required to pay for the wireless device and the services received on a monthly subscription basis. If funds are not paid as required, the jurisdiction is notified and the service is suspended. The payment methods can vary. In one embodiment, the offender is anticipated to deposit the funds for the equipment and services in an account controlled by the offender. In another embodiment, the offender's family members deposit the funds on behalf of the offender in an account controlled by the family members. In yet another embodiment, the jurisdiction supervising the offender deposits the funds on behalf of the offender in an account established for and controlled by the jurisdiction. Other embodiments of payment include a pay as you go method. According to one embodiment, the payment accounts for the offenders are stored on any server accessible within the system, including the OMS/JMS server and the Central server 101. Other account storage configurations are possible according to other embodiments.

### Wireless Device

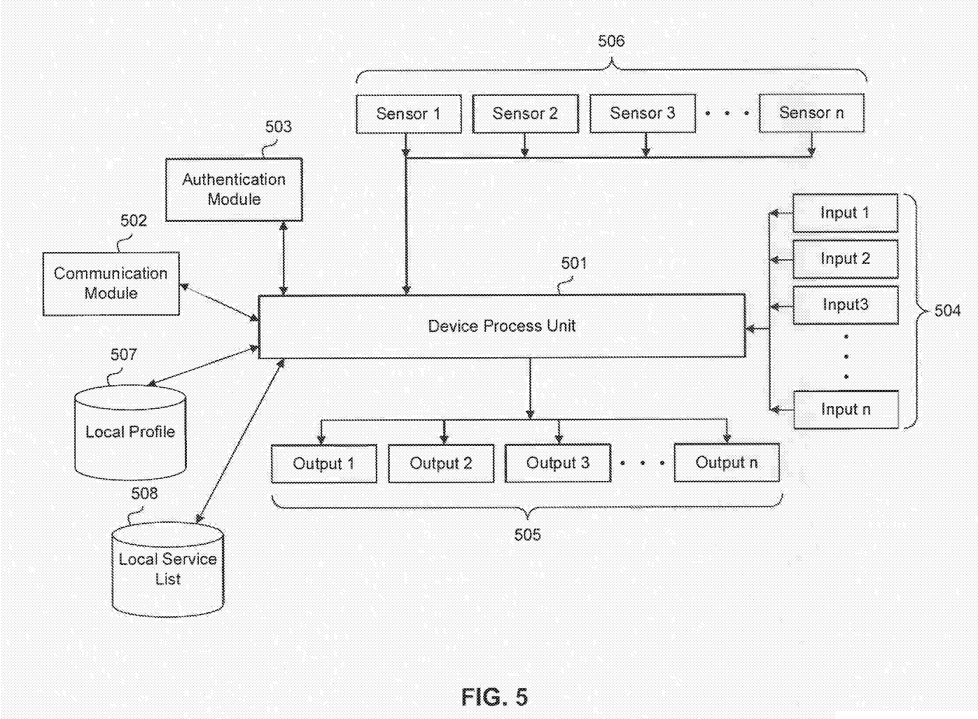

FIG. 5 provides a block diagram of a Wireless Device 106. According to an embodiment shown by FIG. 5, Wireless Device 106 includes a Device Process Unit 501, a Communication Module 502, an Authentication Module 503, a plurality of Input 504, a plurality of Output 505, a plurality of Sensor 506, a Local Offender Profile 507, and a Local Service List 508. The Device Process Unit 501 communicates with the other components 502, 503, 504, 505, 506, and 507, and provides functions that include, but are not limited to, receiving and sending data, processing data, and executing predefined actions. For example, the offender uses the Wireless Device for communication purpose. In an exemplary embodiment, the Device Process Unit 501 receives the offender's Biometric data from one or more of the Sensor 506, sends the data to Authentication Module 503 to authenticate the Offender's identify, and receives voice or video input from one or more of the Input 504. Then the Device Process Unit 501 sends the voice or video data to Communication Module 502, which then sends the voice or video data to the network.

In another example, the Device Process Unit 501 receives location data from one or more of a Sensor 506 (e.g. a GPS sensor) and sends the data to the Communication Module 502, which then sends the location data to the Central Server 101 through the network connections.

The Communication Module 502 provides functions that include, but are not limited to, storing data, receiving data from and sending data to Device Process Unit 501, receiving data from and sending data to the other components in the OTAS 100 through the network connections. As mentioned above, the network connections can be any form of wired or wireless connections.

The Authentication Module 503 provides functions that include, but are nor limited to, receiving offender identity data (e.g. biometric information) and comparing the identity data with the data of the authorized user. The Authentication Module also authenticates Jurisdiction officials so that they can modify, refresh or reset the Wireless Device.

A plurality of the Input 504 comprise a number input means for the Wireless Device 106. The input means include, but are not limited to, input from a keyboard, a microphone, a camera, a touch screen, and a force detector. The different input means receives data from the offender and sends the data to the Device Process Unit 501 for analysis and processing.

A plurality of the Output 505 include a number of output means for the Wireless Device 106. The output means include, but are not limited to, output to a screen for text display, a speaker, and a vibrator.

A plurality of the Sensor 506 include a number of different sensors for the Wireless Device 106. The different sensors include, but are not limited to, a GPS sensor, a gyroscope sensor, a temperature sensor, a humidity sensor, and a force sensor.

The Local Offender Profile 507 includes detailed data about the offender, such as Personal Records, Needs, Goals, Offender Category, Offender Phase, Offender Release Location, Supervision Level, and Offender Behavior Monitor Status. The Local Offender Profile is updated with new data regarding the offender and is synchronized with the Profile 202 of the Central Server 101.

The Local Service List 508 is a list of services that are currently provided to the offender. The services and functions include, but are not limited to, Monitor service, Notification service, Education service, Job service, Communication service, Entertainment service, and Schedule service. The Local Service List 508 is synchronized with the Service List 205 of the Central Server 101.

### System Operation: Profile and Service List Generation and Wireless Device Initialization

The system operation for the profile and service list generation and wireless device initialization of the OTAS 100 will be illustrated and described in derail with regard to different embodiments of the present disclosure.

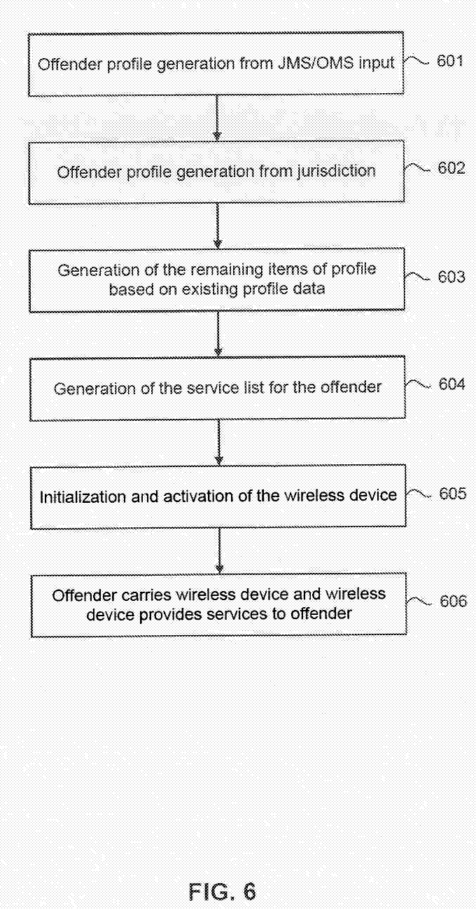

FIG. 6 illustrates a flowchart diagram of methods of Profile Generation and Service Initialization, according to one embodiment of the present disclosure. The first step is to build an first portion of Profile 202 for the offender, as illustrated in 601. When the defender enters the correction facility, an empty default profile is used to generate the Profile 202 for the offender by the Central Server 101. The JMS/OMS 102 sends the criminal record of the offender to the Central Server 101 to fill in the Personal Records portion of Profile 202. This criminal record of JMS/OMS is input and managed by the Jurisdiction officials. If the offender is a first time offender, a new JMS/OMS record is built for the offender by the Jurisdiction officials. Otherwise, the record is updated from an existing record by the Jurisdiction to i effect the update-to-date information.

At 602, the Jurisdiction officials input data and build the second portion of Profile 202. At the correction facility, jurisdiction officials do a complete review of the offender's history and criminal record, and hold personal interviews for the offender. During the personal interviews, the Jurisdiction officials identify the needs of the offender, set up goals for the offender if agreed by the offender, identify the offender category of the offender and the phase of the offender. For example, the need of the offender is “Mental Health Improvement”, the Goal of the offender is “No mental disorder for 6 month”, the Category of the offender is “High Risk”, and the phase of the offender is “Incarcerated” if the offender just enters the correction facility. The Jurisdiction officials then input the data of the offender to the Central Server 101 and complete the generation of the second portion of Profile 202 for the offender. An exemplary method for the Jurisdiction officials to create or update information tor the offender in Central Server 101 is filling out specific forms on Terminal 104. An example of a Terminal 104 may be a personal computer.

At 603, a third portion of the Profile 202 is generated based on the existing portion of the Profile 202 built in 601 and 602. The Process and Analysis Unit 201 in the Central Server 101 analyzes the existing data of Profile 202, and automatically generates the remaining portion of Profile 202 based on the Rule 203. For instance, for an offender who just comes in the correction facility with high degree assault, the Process and Analysis Unit (PAU) 201 analyzes the Personal Records of the offender and identifies that the offender had a long history of high degree assaults. Based on Rule 203, such offender falls into an Offender Category 304 of “High Risk”. The PAU 201 then writes “High Risk” to fill in the Offender Category 304. The Process Analysis Unit 201 also identifies that the Offender Phase 305 is “Incarcerated”, and none of the Goals 303 are marked complete. Based on Rule 203, the Supervision Level 307 should be the highest level (for example, Level 3), and the PAU 201 writes Level 3 in the Supervision Level 307. The Offender Activity Monitor 308 is reset to all default status because the offender just enters the correction facility and no monitor record has been collected. As a result, the PAU 201 is configured to generate the data to complete the offender's Profile 202, based on the existing portions of Profile 202 and the predefined Rule 203. In another exemplary embodiment, all portions of the Profile 202 are generated manually. For example, the Jurisdiction officials override the Rules 203 and manually input the information to complete the Profile 202. In yet another exemplary embodiment, most portions of the Profile 202 are generated automatically. For example, the PAU 201 is configured to generate all the portions of the Profile 202 based on only Personal Records and a predefined Rule 203.

At 604, a Service List 205 for the offender is generated after the generation of the Profile 202 at 603. Depending on the offender, a specific and personalized Service List 205 is generated to provide the services to the offender. The generation of the Service List 205 is realized by selecting a list of services from the Available Service Database 204 according to the offender's Profile 202. For example, the PAU 201 analyzes the offender's Needs 302 in Profile 202 and identifies that the offender has a need for “Mental Health Improvement”. Based on the Rule 202 Selection rules, the PAU 201 selects mental health related services for the offender, such as scheduling an appointment with a mental health doctor, or online mental health education courses. For another example, the PAU 201 analyzes the offender's Goals 303 in Profile 202 and identifies that the offender has a Goal to obtain an GED course. Based on the Selection rules in Rule 202, the PAU 201 selects GED course related services from the Available Service Database 204 for the offender, such as GED course registration, online course materials, and online course homework submission and evaluation. In an exemplary embodiment, the Service List 204 is constantly updated manually or automatically. For example, an input from the jurisdiction officials to add a specific service is done when the officials send new service request to the Central Server 101 via a Terminal 104. PAU 201 executes the request and adds the specific service to the Service List 204. As another example, the Service List 204 is automatically updated by the PAU when the offender's activity meets certain goals according to predefined rules. According to an exemplary embodiment, such selection of services based on the offender Profile 202 is included in one or more Selection rules in Rule 203.

At 605, the Wireless Device 106 is initialized and activated for the offender after the Service List 204 is generated at 604. In an embodiment, the Wireless Device 106 downloads the offender's Profile 202 and the Service List 204 from the Central Server 101 to the Local Profile 507 and Local Service List 508 on the Wireless Device 106. In another embodiment, the Wireless Device 106 does not have a local Service List 508, and the Wireless Device 106 provides all the services listed in the Service List 204 located in the Central Server 101 by constantly communicating with the Central Server. In another embodiment, the Wireless Device 106 does not have the Local Profile 507 and constantly communicates with the Central Server 101 to obtain and updates the offender's information in Profile 202 on the Central Server 101. The Authentication Module 503 of the Wireless Device 106 is configured to recognize the intended offender as an authorized user.

At 606, the offender carries one or more of the Wireless Device 106 after the device's initialization and activation at 605. The Wireless Device 106 provide services to the offender. In an exemplary embodiment, the Wireless Device 106 is a single portable device. In another exemplary embodiment, the Wireless Device 106 is more than one portable devices that communicate with each other, and each of the portable devices communicates with the Central Server 101 and one or more Remote Server 103.

### System Operation: Progressive Transition Assistance with Positive Feedback

The system operation of the OTAS 100 with a positive feedback mechanism to help the offender's transition will be illustrated and described in detail with regard to different embodiments of the present disclosure.

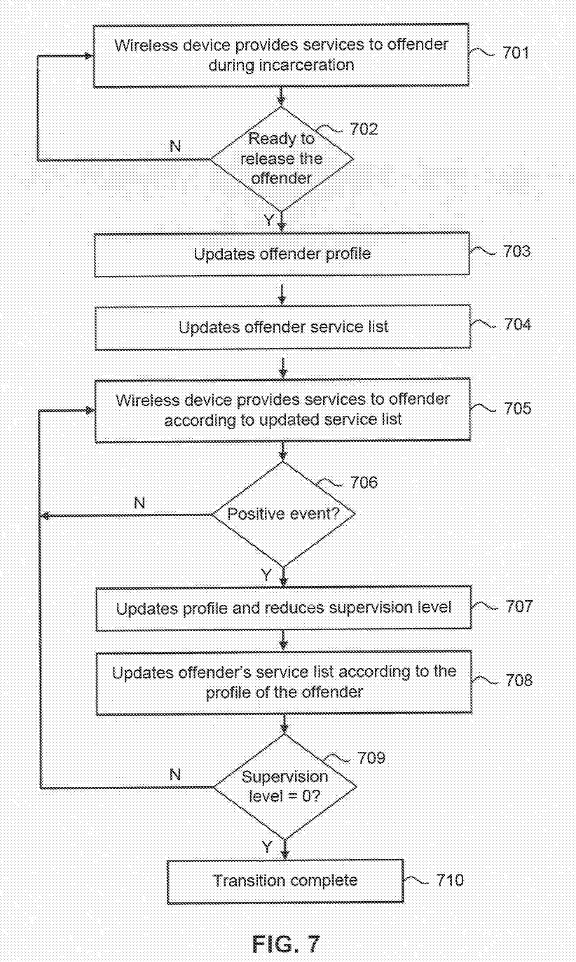

FIG. 7 illustrates a flowchart diagram of the system operation for the transition assistance services provided by the GTAS 100 with a positive feedback mechanism, according to an embodiment presented in this disclosure. At 701, the Wireless Device 106 provides services to the offender according to the offender's Service List 205 when the offender is incarcerated.

At 702, the offender is evaluated by the Jurisdiction officials on whether the offender is ready to be released and start the transition process. If the offender is not ready to be released, the OTAS 100 goes back to 701, and the Wireless Device 106 continues to provide services to the offender according to the offender's Service List 205. If the offender is determined to be ready for release, the OTAS 100 reacts to this event and move to 703 and starts the transition process.

At 703, the transitioning offender's Profile 202 is updated to reflect the changes caused by the release event. The Profile 202 updates include, but are not limited to, Personal Records 301 update, Needs 302 update, Goals 303 update, Offender Category 304 Update, Offender Phase 305 update, Offender Release Location 306 update. Offender Supervision Level 307 update, etc. For example, the Needs 302 is updated to include new needs after the offender is released, such as Job skill training. The Goals 303 is updated to include new goals to help guide the transitioning offender through the transition process. Some examples of goals include:

Attending Counseling sessions regularly for a certain period of time

Staying on schedule for a certain period of time

Completing all the assigned study courses

Obtaining a General Education Degree (GED)

Abstaining from substance abuse

Abiding by the rules and regulations of the jurisdiction

Meeting with support groups regularly for a certain period of time

Meeting with the parole officer on time for a certain period of time

The goal status of the Goals 303 is also updated or reset to reflect the changes caused by the release event. The Offender Phase 305 is updated from “Incarceration” to “Conditional Release” or “Full Release” depending on the actual situation. The Offender Release Location 306 is updated to the target location where the transitioning offender will be released to, or to the residence address of the transitioning offender's halfway house. The Release Location 306 is used to identify the undesired locations for the transitioning offender to avoid.

According to an embodiment, the Supervision Level 307 is also updated at 703. The Supervision Level 307 is an indicator of the intensity or frequency of the transition assistance services provided to the transitioning offender. In one exemplary embodiment, the Supervision Level 307 is a single global level which determines the intensity or frequency of all services. In another exemplary embodiment, the Supervision Level 307 may be a collection of levels each of which corresponds to a specific category of services. Supervision Level 307 is updated to a desired level or levels for the transitioning offender to start the transition period. For example, the supervision level have 4 levels from level “0” to level “3”, with “0” being no supervision and “3” being the most intensive supervision. When the transitioning offender is just released to society, the Supervision Level 307 may be set to “3” for all levels to apply the most intensive supervision assistance services to the transitioning offender. The Supervision Level 307 is used, together with other data in Profile 202 corresponding to the transitioning offender (e.g. Offender Category 304), by the Central Server 101 to determine the Service List 205 for the transitioning offender. A higher Supervision Level 307 corresponds to a Service List 205 with more supervision assistance service items and a higher frequency for the supervision assistance services. Offender Category 304 is also used to determine the services for the transitioning offender. A transitioning offender with an Offender Category 304 of “High Risk” has a Service List 205 with more intensive supervision assistance services than a transitioning offender with an Offender Category of “Low Risk”, even if the Supervision Level 307 for both offenders may be the same. As a result, the Offender Category 304 is utilized to categorize the transitioning offenders and direct more supervision assistance services to the transitioning offenders with higher risk of recidivism. The matching between specific services and specific Supervision Level 307 is illustrated in a matching table below, according to an embodiment of the present disclosure:

| Supervision | Supervision | | |
|---|---|---|---|
| Level- | Level- | Communication | |
| Communication | Schedule | Monitoring | Mandatory Daily Scheduling |
| 3 | 3 | Always On | Schedule all activities |
| 2 | 3 | 75% of the time On | Schedule all activities |
| 1 | 3 | 50% of the time On | Schedule all activities |
| 0 | 3 | Always Off | Schedule all activities |
| 3 | 2 | Always On | Schedule all supervisory activities |
| 2 | 2 | 75% of the time On | Schedule all supervisory activities |
| 1 | 2 | 50% of the time On | Schedule all supervisory activities |
| 0 | 1 | Always Off | Schedule some supervisory activities |
| 3 | 1 | Always On | Schedule some supervisory activities |
| 2 | 0 | 75% of the time On | No Mandatory Scheduling |
| 1 | 0 | 50% of the time On | No Mandatory Scheduling |
| 0 | 0 | Always Off | Mo Mandatory Scheduling |

The matching Table above shows 4 supervision levels for both monitor service and schedule service. One should be reminded that the Supervision Level 307 can have more levels or less levels. One should also be reminded that the services matching to Supervision Level 307 in the table is only for illustration purpose. In one exemplary embodiment, the Supervision Level 307 comprises separate levels and each level corresponds to a specific subset of services. As an example, the Supervision Level 307 comprises 4 levels, including Location Supervision Level, Communication Supervision Level, Probation Supervision Level, and Schedule Supervision Level. In the matching table above, only the Communication Supervision Level and the Schedule Supervision Level are listed. There can be more than 4 levels corresponding to more service subsets. In another embodiment, the Supervision Level 307 is a single global level which impacts all the services. One should be noted that the actual matching between the Service List 205 and Supervision Level 307 can be defined in ways different from a matching table depending on the need of the specific application. Further, such matching table or matching rules are defined in Rules 203 in the Central Server 101, according to an embodiment. In some embodiments, there are more than one table or rule for the Central Server 101 to choose from, and the tables or rules for a specific transitioning offender are determined manually and/or automatically.

At 704, the Service List 205 corresponding to the transitioning offender is updated according to the updated Profile 203. As disclosed at 703, the Service List 205 is updated by matching the desired services and service frequencies to the Offender Category and Supervision Level, based on predefined matching tables or rules.

At 705, the transitioning offender carries the Wireless Device 106 and the device provides the desired services to the transitioning offender according to the updated offender's Service List 205 on the Central Server 101, according to an embodiment of the present disclosure. In another embodiment, the Wireless Device 106 downloads the Service List 205 to Local Service List 508. Wireless Device 106 provides services based on Local Service List 508. In yet another embodiment, the Wireless Device 106 may downloads the transitioning offender's Profile 202 to Local Profile 507.

At 706, the OTAS 100 is waiting for a positive event to trigger the positive feedback mechanism. If no positive event occurs, the OTAS 100 goes back to 705 and no update occurs in the transitioning offender's Service List 205. The Wireless Device 106 continues to provide the services according to the Service List 205. If a positive event happens, the OTAS 100 system is triggered to activate the positive feedback mechanism and move to 707. A positive event is an event which indicates that the transitioning offender is making progress in forming good behaviors and moving towards completing the transition. Some examples of positive events are:

Completing a goal or reaching a milestone of a goal progress

Making progress in Offender Phase

Positive trend identified in Offender Activity Monitor

Positive Feedback from the jurisdiction

At 707, the OTAS 100 responds to the positive event by updating the transitioning offender's Profile 202 including updating the Supervision Level 307. This action is completed by the Central System 101 according to the nature of the positive event and the positive feedback mechanism. In one embodiment, if the transitioning offender completed a Goal for reporting to the Probation Officer for 6 months in a row, the OTAS first determines that the transitioning offender's Probation Supervision Level should be reduced by 1 level according to the positive feedback mechanism for this offender. Then the OTAS 100 updates the transitioning offender's Profile 202 and reduces the Probation Supervision Level by 1 level. In another embodiments, the transitioning offender's Supervision Level is a single global level that applies to all services, and the reduction in Supervision Level 307 is determined by different mechanisms. Besides the update in Supervision Level 307, the Goals 303 in this offender's Profile 202 is also updated to mark this specific Goal as complete. One should be noted that in some embodiments there are more than one positive feedback mechanisms stored in the Rule 203, and each transitioning offender has a mechanism that best fits the offender's own learning cycle.

At 708, the transitioning offender's Service List 205 is updated according to the update in the update in Supervision Level 307 and the update in the offender's Profile 202. In the case that the Probation Supervision Level is reduced, the transitioning offender's probation supervision assistance services in Service List 205 are relaxed, according to the matching table or rule. Such relaxation in the supervision assistance services act as a reward to encourage the transitioning offender to keep repeating the positive behaviors and to form a good habit. Such progressive reduction in supervision assistance services also gradually change the life style of the offender and smoothen the offender's transition process. In an exemplary embodiment, the Service List 205 includes a notification service to provide positive notification, such as a congratulation message on the Wireless Device 106, a sound message, or a vibration alert to notify the transitioning offender for the achievement. In another embodiment, the Service List 205 also includes a communication service to send the achievement message to Jurisdiction officials and friends and family of the transitioning offender, and to receive encourage messages from the officials and friends and family. The positive feedback from the system, the Jurisdiction officials, and the friends and family boost the offender's confidence and self-esteem, which benefits the offender and reduces the chance of recidivism.

At 709, the OTAS 100 system determines if the transition process is complete. One example of such determination is by comparing the Supervision Level 307 to the lowest level, or “0”, according to an embodiment presented in this disclosure. For example, the Supervision Level 307 comprises a list of levels that correspond to different service categories. If all the levels is “0” or at lowest levels, the transition is considered complete. Otherwise, the transition is considered not complete. If the transition is not complete at 709, the OTAS 100 goes back to 705. The Wireless Device 106 provides the updated services to the transitioning offender according to the Service List 205 updates at 708. If the transition is complete, the OTAS 100 moves to 710. In another example, the Supervision Level 307 is a single global level that applies to all services. In this case, if the Supervision Level 307 is “0”, the transition is considered complete.

At 710, the offender completes the transition. The Wireless Device 106 still provides the updated services according to the updates in Service List 205 corresponding to the offender. According to an embodiment, the supervision assistance services are completely removed from the Wireless Device 106. The OTAS 100 also send out notification to the offender, the jurisdiction and the friends and family of the offender to notify the completion. The offender can decide to turn in the Wireless Device 106 or keep using the device as a tool. When the Wireless Device 106 is returned, the wireless device is reset and can be later used by other offenders, as shown in 605 in FIG. 6.

### System Operation Example: Communication Monitor with a Positive Feedback Mechanism

The operation of the system with Communication Monitor under a positive feedback mechanism will be illustrated in detail. In this embodiment, the OTAS 100 system provides communication monitoring service to the transitioning offender by tracking the offender's communication with peers, friends, family members, or jurisdiction. A positive feedback mechanism is utilized in this service to provide progressive transition assistance during the offender's transition.

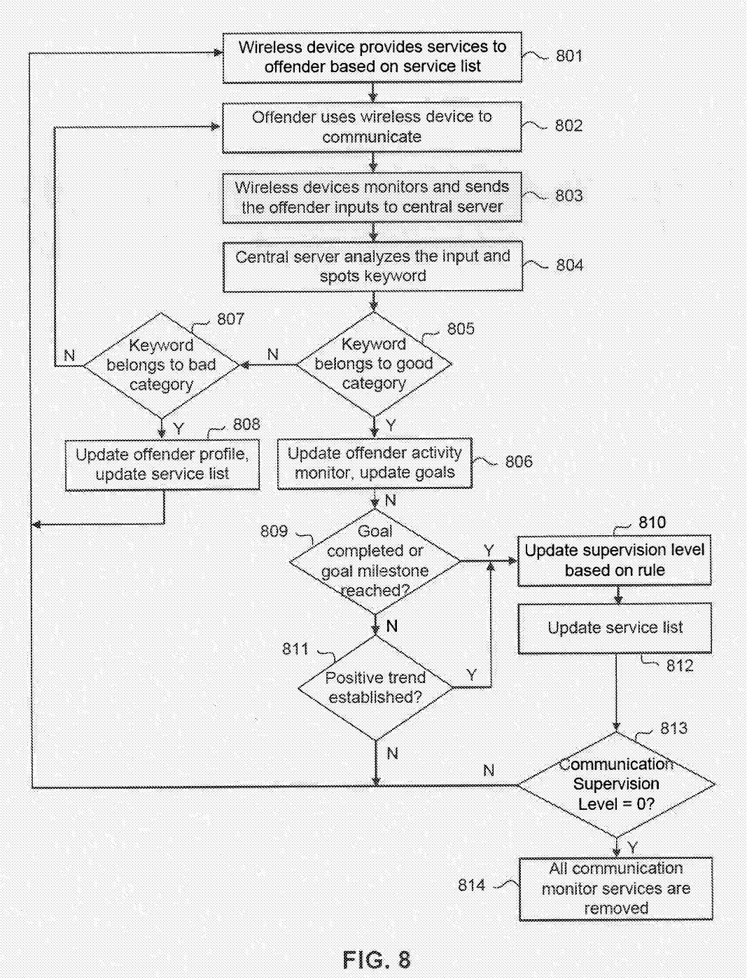

FIG. 8 illustrates a flowchart diagram of the system operation for the communication monitor services with a positive feedback mechanism provided by the OTAS 100, according to an embodiment presented in this disclosure. At 801, the Wireless Device 106 provides services to the transitioning offender according to the offender's Service List 205. In another embodiment, the Wireless Device 106 downloads the Service List 205 to Local Service List 508, and the Wireless Device 106 provides services to the transitioning offender according to the Local Service List 508.

At 802, the transitioning offender uses the Wireless Device 106 for communication with others. The communication is in the form of text messages, phone calls, emails or other forms that the Wireless Device 106 supports. The transitioning offender uses one or more of the Input 504 on the Wireless Device 106 to create the communication message. As an example, the offender uses a keyboard to type in a text message, or use the speaker to create a voice mail, or make a phone call or video call using the speaker or the camera. The Authentication Module 503 of the Wireless Device 106 authenticates the identity of the offender before enabling the communication services.

At 803, the Wireless Device 106 monitors the communication data created by the transitioning offender via one or more of the Input 504 on the Wireless Device 106. The Wireless Device 106 sends the communication data to the Central Server 101 for communication data analysis.

At 804, the Central Server 101 receives the communication data sent from the Wireless Device 106 and spots the keywords in the data. For example, the Central Server analyzes a text message sent by the transitioning offender and spots the keywords in the message in the text message using a predefined algorithm. The Central Server 101 also analyzes voice messages sent by the offender and spot the keywords in the dialogue using a voice recognition technology and a predefined algorithm.

In an exemplary embodiment, evaluating the communication messages by keyword spotting is executed by categorizing the keywords into good and bad behavioral groups. By doing so, the Central Server 101 reacts to different categories of keywords with pre-determined actions. An example of categorizing and grouping the keywords is illustrated in the table below. The Trigger words are the keywords that the Central Server 101 can spot in a message. The Trigger words include some characteristic words that carry important meaning, such as the transitioning offender's emotion, opinion, action, and mental status. One should be noted that the Grouping Table below is only for illustration purpose, and actual definitions and grouping of the keywords can be defined and modified by the jurisdiction based on the specific situation. One should also be noted that, although not illustrated in the Grouping Table, in some examples the keywords may not belong to Good Behavior nor Bad Behavior. In some examples, the keywords can be neutral.

| Behavior | Type | Group | Trigger |
|---|---|---|---|
| Good | Reactors | Compassionate, Sensitive and warm | Emotional Words |
| | Dedicated | Responsible, Logical and Organized | Thought Words |
| | Persister | Conscientious, dedicated and | Opinion Words |
| | | Observant | |
| | Dreamers | Reflective, Imaginative and Calm | Reflection Words |
| | Rebels | Creative, Spontaneous and Playful | Action Words |
| Bad | Prohibited | Criminal Related | Criminal or Gang Words |
| | Immoral | Inappropriate | Curse or Slang Words |
| | Violating | Inappropriate | Inappropriate Words |
| | Abusive | Psychological and Stressful | Demining or Abusive Words |
| | Self- | Self-denying | Unhappy, Sad, or Confused |
| | denial | | Words |
| | Agitated | Upset and Uneasy | Mad, Angry, and Scared Words |

At 805, after a certain Trigger keyword is spotted, the Central Server 101 analyzes the keyword and finds out its Behavior Category based on the predefined rules, such as the grouping table above. If the spotted keyword belongs to the Good Behavior Category, the OTAS 100 moves to 806 to initiate the positive feedback actions. If the spotted keyword does not belong to the Good Behavior category, the OTAS 100 moves to 807 to determine if the keyword belongs to the Bad Behavior category. If the keyword belongs to the Bad Behavior Category, the OTAS 100 proceeds to 808 to initiate a notification or warning service, according to some embodiments. In another embodiment, the OTAS 100 reacts to keywords from the Bad Behavior category by initiating a punishment feedback or other form of feedback. In this example shown by FIG. 8, only s notification or warning service is illustrated. At 807, if the keyword does not belong to the Bad Behavior category, the keyword is neutral and the OTAS 100 returns to 802. No change in Service List 205 occurs and the transitioning of fender continues to communicate.

At 808, the keyword that belongs to the Bad Behavior category triggers a notification or warning service, as described above at 807. Consequently, the Central Server 101 updates the transitioning offender's Profile 202 and Service List 205 according to this spotted keyword. For example, if the transitioning offender has a goal to keep good communication behavior for a certain period of time, the Central Server 101 updates the offender's Goal Status by resetting the status to the beginning due to the occurrence of a bad communication. The Service List 205 is also updated to include a notification or warning message to notify the transitioning offender for this bad communication and the change in goal status. In another example, the Service List 205 is not updated to include the notification or warning unless the transitioning offender repeats the bad communication for a certain amount of time. After the Profile 202 and Service List 205 updates, the OTAS 100 goes back to 801 and the Wireless Device 106 provides the updated services according to the updated Service List 205. In the embodiment shown by FIG. 8, the Wireless Device 106 displays the notification or warning message to the transitioning offender for the bad communication behavior. The transitioning offender may still continue to communicate at 802.

At 806, the OTAS 100 initiates the positive feedback since the spotted keyword is in the Good Behavior category, as described above at 805. The Central Server 101 updates the transitioning offender's Profile 202 according to the keyword. For example, the Central Server 101 updates the goal status of the transitioning offender's Goals 303, if the transitioning offender has a goal to keep good communication for a certain period of time. If the transitioning offender completes a goal or reach a goal milestone, the Central Server 101 further updates the Goal Status to reflect the achievement of the offender. In an exemplary embodiment, the Central Server 101 also updates the Communication Record in the offender's Offender Activity Monitor 309. The records in the Offender Activity Monitor 309 are used by the Central Server 101 to identity the trend of the offender's recent behavior. After the updates of the offender's Profile 202, the OTAS 100 proceeds to 809 to determine whether the offender completes a goal or reaches a goal milestone. This step is executed by checking the updates of the goal status in the offender's Profile 202. If the offender completes a goal or reach a goal milestone at 809, the OTAS 100 directly proceeds to step 810 to execute the positive feedback actions. If the offender does not complete a goal nor reach a goal milestone, the OTAS 100 proceeds to 811 to further determine whether a positive trend is established. 811 is executed by checking whether there is a positive trend in the offender's communication record in Offender Activity Monitor 309. If the offender does not establish a positive trend in the communication record, the OTAS 100 moves back to 801 without changes in Service List 205. If, on the other hand, the offender establishes a positive trend in the communication record, the OTAS 100 moves to 810 to execute the positive feedback actions.

At 810, the positive feedback actions starts with Central Server 101 updating the transitioning offender's Profile 202, such as reducing the Supervision Level 307. The Central Server 101 first determines whether there should be a reduction of the Supervision Level 307 and how big the reduction should be, based on predefined rules. These predefined rules ate stored in Rule 203. In the embodiment shown by FIG. 8, the Supervision Level 307 includes the Communication Supervision Level that determines the communication supervision assistance services. In another embodiment the Supervision Level 307 is a single global level that determines all the services. In the embodiment shown by FIG. 8, the Communication Supervision Level is determined to be reduced by 1 level according to an applicable predefined rule. Besides the Supervision Level 307, some other portions of the Profile 202 are also updated, such as Goals 303 and Offender Activity Monitor 308, according to the specific situation.

At 812, the transitioning offender's Service List 205 is updated according to the updated offender's Profile 202, such as the reduced Communication Supervision Level. In the embodiment shown by FIG. 8, the reduction in communication supervision level results in a relaxation of the communication monitor service, according to a predefined rule. As an example, the predefined rule is a communication supervision service to communication supervision level matching table. One of such table is exemplified by the Matching Table discussed at 703. The Service List 205 of the offender is consequently updated to reflect the relaxation in the communication supervision assistance service. The Service List 205 is also updated to include a notification or congratulation message to praise the offender for the good communication behaviors.

After the update of the Service List 205, the OTAS 100 moves to 813 to determine whether the Communication Supervision Level is reduced to level “0” or the lowest level. If the Communication Supervision Level is not “0”, the OTAS 100 moves back to 801 and the Wireless Device 106 provides updated services according to the updated Service List 205. In the embodiment shown by FIG. 8, the Wireless Device 106 reduces the communication supervision service for the transitioning offender. It also displays a notification or congratulation message to the offender to encourage the offender's good communication behavior. If the Communication Supervision Level is “0”, the OTAS 100 moves to 814. At 814, the OTAS 100 completely removes the communication supervision assistance service for the offender. For example, the Wireless Device 106 no longer monitors the communication messages generated by the offender. In other words, the offender completes the transition from being tightly monitored for communication to no communication monitoring.

In summary, the OTAS 100 enables a progressive communication monitor service for the transitioning offender with a positive feedback mechanism. Such a positive feedback mechanism rewards the offender's good communication behavior and gradually relaxes the communication supervision when the offender gradually builds up the good conversation behavior. At the end of the transition, the offender may have formed a good habit in communication and may be ready for normal life communication. Such a progressive supervision assistance service gradually reduces the monitoring of the offender's communication to transition from tightly monitored to no monitoring. In addition, it helps the offender build up a good behavioral habit by constantly praising and rewarding the offender for good behaviors. As a result, the good behaviors becomes enhanced and the chance of recidivism is reduced.

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

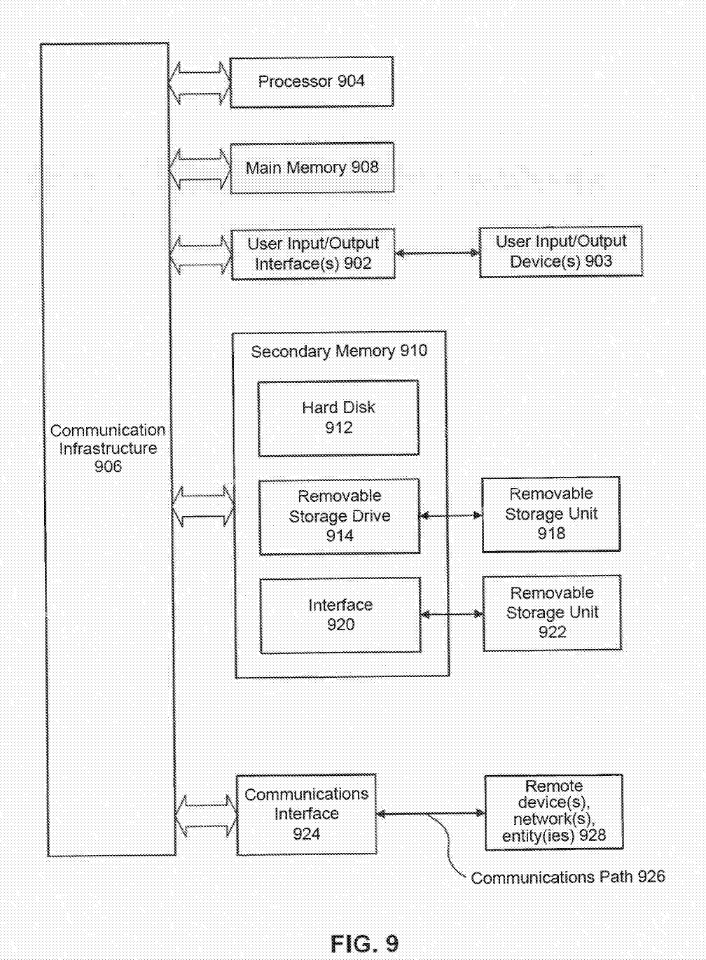

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the Central Server 101, JMS/OMS 102, Remote Server 103, Terminal 104 and 105, and the methods of FIGS. 6-8 can be implemented in the environment of one or more computer systems or other processing systems. An example of such as computer system 900 is shown in FIG. 9.

Computer system 900 includes one or more processors, such as processor 904. Processor 904 can be a special purpose or a general purpose digital signal processor. Processor 904 is connected to a communication infrastructure 906 (for example, a bus or network). Various software implementations are described in terms of this exemplary computer system. After reading this description, it will become apparent to a person skilled in the relevant art(s) how to implement the disclosure using other computer systems and/or computer architectures.

Computer system 900 also includes a main memory 908, preferably random access memory (RAM), and may also include a secondary memory 910. Secondary memory 910 may include, for example, a hard disk drive 912 and/or a removable storage drive 914, representing a floppy disk drive, a magnetic tape drive, an optical disk drive, or the like. Removable storage drive 914 reads from and/or writes to a removable storage unit 918 in a well-known manner. Removable storage unit 918 represents a floppy disk, magnetic tape, optical disk, or the like, which is read by and written to by removable storage drive 914. As will be appreciated by persons skilled in the relevant art(s), removable storage unit 922 includes a computer usable storage medium having stored therein computer software and/or data.

In alternative implementations, secondary memory 910 may include other similar means for allowing computer programs or other instructions to be loaded into computer system 900. Such means may include, for example, a removable storage unit 922 and an interface 920. Examples of such means may include a program cartridge and cartridge interface (such as that found in video game devices), a removable memory chip (such as an EPROM, or PROM) and associated socket, a thumb drive and USB port, and other removable storage units 922 and interfaces 920 which allow software and data to be transferred from removable storage unit 922 to computer system 900.

Computer system 900 may also include user input/out interface(s) 902 which provide an interface to user input/output device(s) 903. Such user input/output device(s) 903 may be any device that provides a user access to input and output of computer system 900. Examples of user input/output device(s) 903 may include a keyboard, a computer monitor, a mouse, a camera, and a microphone.

Computer system 900 may also include a communications interface 924. Communications interface 924 allows software and data to be transferred between computer system 900 and external devices 928 which may include remote device(s), other network(s), and other entities. Examples of communications interface 924 may include a modem, a network interface (such as an Ethernet card), a communications port, a PCMCIA slot and card, etc. Software and data transferred via communications interface 924 are in the form of signals which may be electronic, electromagnetic, optical, or other signals capable of being received by communications interface 924. These signals are provided to communications interface 924 via a communications path 926. Communications path 926 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 918 and 922 or a hard disk installed in hard disk drive 912. These computer program products are means for providing software to computer system 900.

Computer programs (also called computer control logic) are stored in main memory 908 and/or secondary memory 910. Computer programs may also be received via communications interface 924. Such computer programs, when executed, enable the computer system 900 to implement the present disclosure as discussed herein. In particular, the computer programs, when executed, enable processor 904 to implement the processes of the present disclosure, such as any of the methods described herein. Accordingly, such computer programs represent controllers of the computer system 900. Where the disclosure is implemented using software, the software may be stored in a computer program product and loaded into computer system 900 using removable storage drive 914, interface 920, or communications interface 924.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

What is claimed is:

1. An system for assisting a transitioning offender during a transition from incarceration to release, the system comprising:
a profile database that stores a plurality of profiles, each of the plurality of profiles corresponding to an offender, the plurality of profiles including a profile of the transitioning offender;
one or more processors and/or circuits configured to:
receive updates corresponding to the transitioning offender;
adjust the profile of the transitioning offender based on the updates; and
set a list of services applied to the transitioning offender;
a rules database that stores a plurality of rules that define how the list of services is set and how the profile is adjusted; and
a service database that stores a plurality of services available to the transitioning offender.

2. The system of claim 1, wherein the rules defining how the list of services is set cause the one or more processors to:
select, based on the profile corresponding to the transitioning offender, a list of services from the service database,
modify, based on the update from the transitioning offender, the list of services, and
apply the list of services to the transitioning offender.

3. The system of claim 2, wherein the one or more processors modifying the list of services further comprises:
adding services to the list of services from the service database;
removing services from the list of services; and
changing the intensity or frequency of one or more services from the list of services.

4. The system of claim 1, wherein the profile comprises one or more service levels, each of the plurality of service levels corresponding to a subset of the list of services applied to the transitioning offender.

5. The system of claim 4, wherein the one or more of the plurality of service levels are configured to determine the intensity or frequency of said subset of the list of services corresponding to the transitioning offender.

6. The system of claim 1, wherein the profile corresponding to the transitioning offender further comprises:
goals corresponding to the transitioning offender; and
activity monitors corresponding to the transitioning offender.

7. The system of claim 1, wherein adjusting the profile corresponding to the transitioning offender comprises adjusting the one or more service levels.

8. An system for assisting a transitioning offender during a transition from incarceration to release, the system comprising:
one or more processors configured to:
receive updates corresponding to the transitioning offender; and
set a list of services applied to the transitioning offender;
a rules database that stores a plurality of rules defining how the list of service was set; and
a service database that stores a plurality of services available to the transitioning offender.

9. The system of claim 8, wherein the plurality of services comprise:
one or more of supervision services comprising at least one of:
communication monitoring;
location monitoring;
daily mandatory activity scheduling;
probation reporting monitoring;
job status monitoring; and
education monitoring; and
one or more of non-supervision services comprising at least one of:
telecommunication services;
notification services;
entertainment services; and
education assistance services.

10. The system of claim 8, wherein the updates corresponding to the transitioning offender comprise updates in:
one or more goals corresponding to the offender; or
activity monitors corresponding to the offender.

11. The system of claim 8, wherein the plurality of rules in association with setting the list of services comprise causing the one or more processors to:
select a list of services from the service database;
modify the list of services; and
apply the list of services to the transitioning offender.

12. The system of claim 8, wherein the one or more processers are configured to transmit a notification to the transitioning offender based on the updates from the transitioning offender.

13. A method for assisting a transitioning offender during a transition from incarceration to release, the method comprising:
generating a profile for the transitioning offender;
setting a list of transition assistance services to the transitioning offender;
receiving updates from the transitioning offender; and
modifying the list of transition assistance services of the transitioning offender based on the updates from the transitioning offender.

14. The method of claim 13, wherein the setting the list of transition assistance services to the transitioning offender comprises:
selecting the list of transition assistance services, based on the profile corresponding to the transitioning offender, from a plurality of available transition assistance services, for the transitioning offender; and/or
applying the list of transition assistance services to the transitioning offender.

15. The method of claim 13, wherein generating the profile of the transitioning offender comprises generating a supervision level for the transitioning offender.

16. The method of claim 15, wherein generating a supervision level comprises generating a plurality of levels, each level configured to determine the intensity or frequency of a subset of the transition assistance services.

17. The method of claim 13, wherein generating the profile of the transitioning offender further comprises:
generating a plurality of goals for the transitioning offender; and
generating a plurality of activity monitors for the transitioning offender.

18. The method of claim 13, wherein modifying the list of transition assistance services comprises:
modifying the supervision level corresponding to the transitioning offender; and
modifying the list of transition assistance services for the transitioning offender based on the modified supervision level.

19. The method of claim 13, wherein modifying the supervision level comprises reducing the supervision level of the transitioning offender, thereby reducing the intensity or frequency of one or more transition assistance services corresponding to the transitioning offender.

20. The method of claim 8 further comprises transmitting a notification to the transitioning offender based on the updates from the offender.
